(19) United States
(12) Patent Application Publication
(10) Pub. No.: US 2015/0282668 A1
(43) Pub. Date: Oct. 8, 2015

(54) BARBEQUE OVEN

(71) Applicants: Hongfeng ZHU, Pudong New District Shanghai (CN); Qianxi CHEN, District Shanghai (CN)

(72) Inventors: Hongfeng Zhu, Yiwu (CN); Qianxi Chen, Yiwu (CN)

(73) Assignee: Hongfeng Zhu, Yiwu, Zhejiang (CN)

(21) Appl. No.: 14/437,010

(22) PCT Filed: Oct. 20, 2012
(86) PCT No.: PCT/CN2012/083253

§ 371 Date: Apr. 20, 2015

(51) Int. Cl. A47J 37/07

(52) U.S. Cl. CPC A47J 37/0704

(57) ABSTRACT

A barbeque oven for use with biomass fuel granule and having a stand placable on the ground and a baking cabinet and an auxiliary equipment on the stand. The baking cabinet has a combustion cabinet and a burner received therein. The baking cabinet further has an outer baking box and an inner baking box. The inner backing box has a plurality of heat dissipating opening defined therein. A density of the heat dissipating openings increases from a proximal end to a distal end of the inner baking box. The auxiliary equipment cabinet has a fuel supplying mechanism and an electrical equipment received therein.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to a barbeque oven for use with biomass fuel, and more particularly, to an oven for baking foods using granule made by smashed and then briquetted straw, bits of wood, or crop stalks.

2. Description of Related Art

Barbeque is a popular way of cooking food. In consideration of safety and convenience, ovens instead of bonfires are more and more often used in barbeques. Combustible gas, carbon, wood pieces are able to be used as fuel for ovens. But biomass fuel, the granule made by mashed and then briquetted straw, bits of wood or crop stalks, are able to cook food with a unique delicacy. As a new energy solution, biomass fuel has been more and more widely used because it is hygienic, environmental, high efficient, and economic. However it is under developed in the field of food baking.

It is desirably that a barbeque oven, has a big area for baking because a bigger area will be able to bake more food and has a higher efficiency. However at the same time, a temperature of the whole area is better even so that a user will not have to turn over or move the food being baked frequently. Since a burner needs to be first air supplied and preferably second air supplied, biomass fuel barbeque oven has to use punctual fire seat. Therefore, how to realize an even baking temperature in a relatively bigger area is a valuable technical problem to resolve.

### BRIEF SUMMARY OF THE INVENTION

The main object of the invention is to provide a barbeque oven for use with biomass fuel which is able to provide an even baking temperature on a long striped area with a punctual fire seat.

In order to accomplish the above objects, the present invention provides a barbeque oven for use with biomass fuel granule and having a stand placable on the ground and a baking cabinet and an auxiliary equipment on the stand. The baking cabinet has a combustion cabinet and a burner received therein. The combustion cabinet has a bottom near the ground, a side extending upward from the bottom, and a top in connection to an upper periphery of the side and facing to the bottom. The burner has a fire grate, a side wall extending upward from the fire grate, and an air supply zone under the fire grate. A burning zone beyond the fire grate is defined by the side wall. A plurality of first air supply holes is defined in the fire grate. A flame tube is above the burner, the flame tube being passing through the top of the combustion cabinet. The baking cabinet further has an outer baking box. The outer baking box is a cuboid having a top opening for placing foods. The outer baking box has an inner baking box therein, the inner baking box being also a cuboid having a bottom opening. A plurality of heat dissipating opening is defined in the inner baking box. One end of the cuboid outer baking box is a proximal end and the other end thereof is a distal end. A flame opening is defined in the bottom at the proximal end, the flame tube being in alignment to the flame opening. A density of the heat dissipating openings increases from the proximal end to the distal end of the inner baking box. The auxiliary equipment cabinet has a fuel supplying mechanism and an electrical equipment received therein. The fuel supplying mechanism has a hopper, a fuel supplying tube having one end in communication to an opening under the hopper and the other end extending into the burning zone, and a rotary vane feeder received in the fuel supplying tube. The electrical equipment has a feeding motor for driving the rotary vane feeder, an air blower which is able to supply air to the air supply zone of the burner, a power supply, and a switch.

The advantageous effect of the invention is that an even temperature on a long striped baking area for a punctual fire seat is realized. Besides the unique delicacy of the foods being baked by the biomass fuel oven, the times of turning overs or movements of a user is decreased.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a schematic perspective view of the preferred embodiment of the oven of the invention.

FIG. 2 is a top plane view of the oven shown in FIG. 1.

FIG. 3 is a cross sectional plane view according to direction A-A shown in FIG. 2.

FIG. 4 is a cross sectional plane view according to direction B-B shown in FIG. 3.

FIG. 5 is a schematic perspective view of an inner baking box of the oven shown in FIG. 1. And,

FIG. 6 is a circuit diagram of an electrical equipment of the oven shown in FIG. 1.

### DETAILED DESCRIPTION OF THE INVENTION

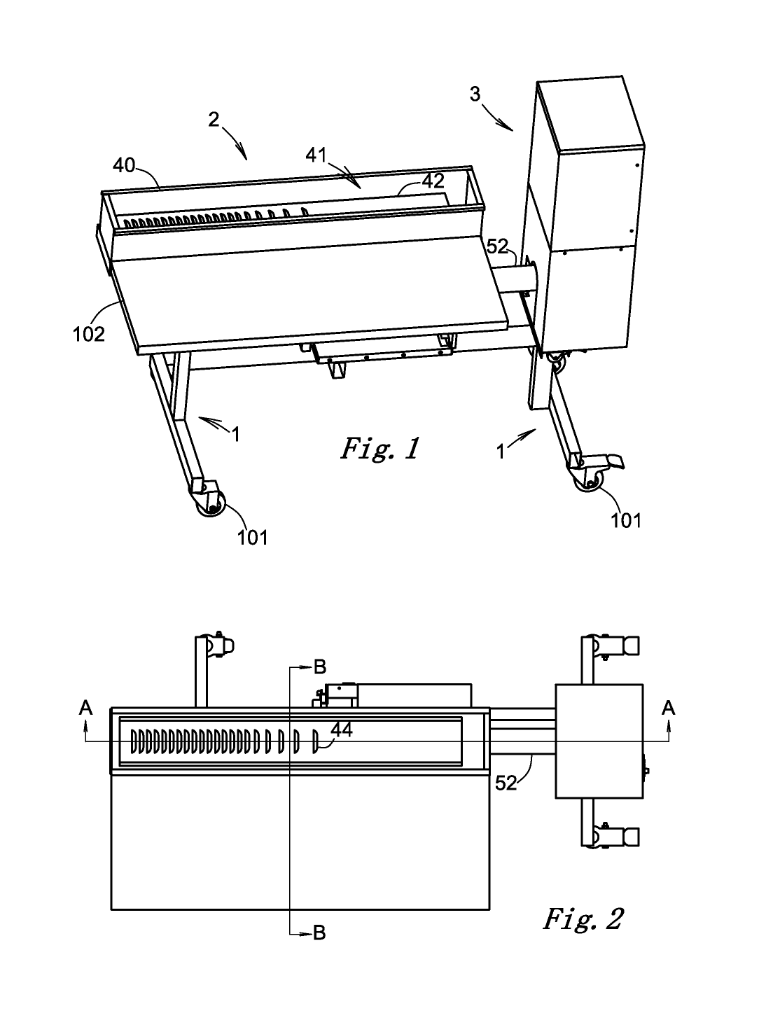

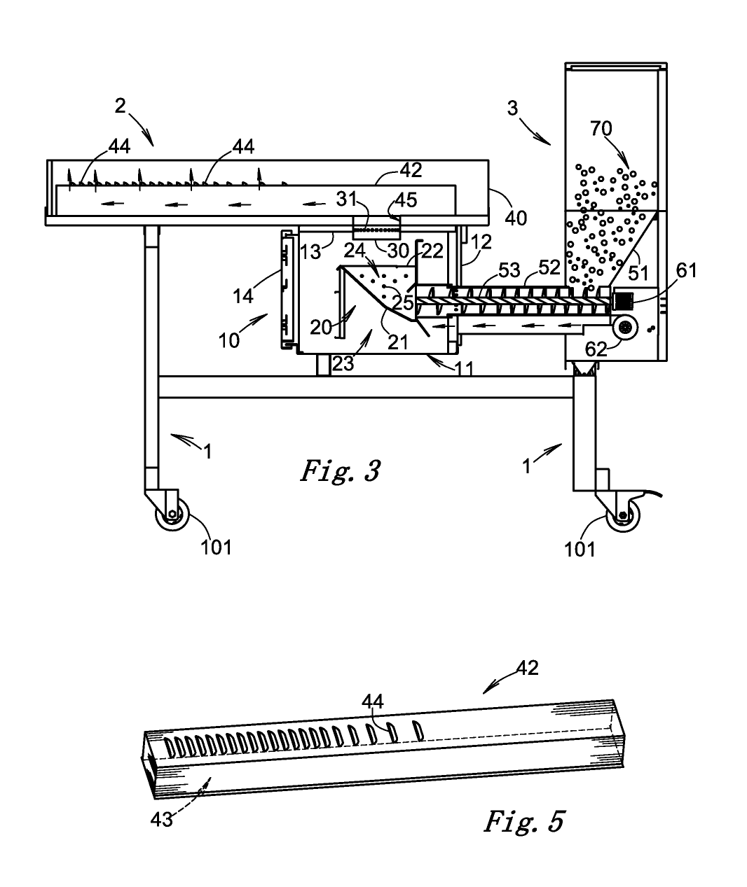

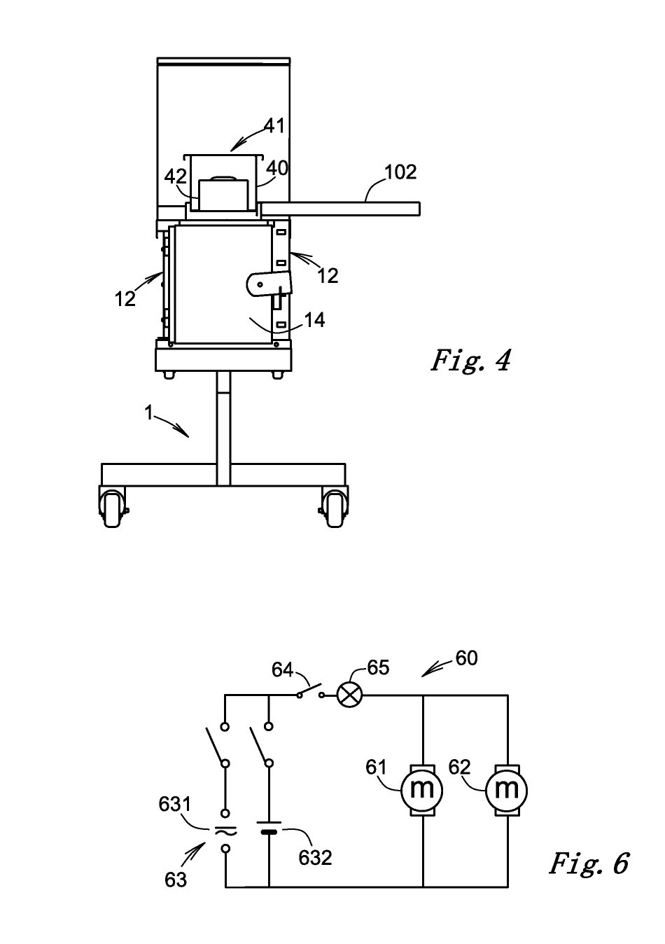

With reference to FIGS. 1, 2, 3 and 4, the preferred embodiment of the invention, a barbeque oven, is shown. The oven has a stand 1 which is able to be placed on the ground. A baking cabinet 2 and an auxiliary equipment cabinet 3 are provided on the stand 1.

The baking cabinet 2 has a combustion cabinet 10. The combustion cabinet 10 has a bottom 11 near the ground, a side 12 extending upward from the bottom 11, and a top 13 in connection to an upper periphery of the side 12 and facing to the bottom 11. An openable door 14 is provided in the side 12.

The combustion cabinet 10 has a burner 20 received therein. The burner 20 has a fire grate 21, a side wall 22 extending upward from the fire grate 21, and an air supply zone 23 under the fire grate 21. A burning zone 24 beyond the fire grate 21 is defined by the side wall 22. A plurality of first air supply holes 25 is defined in the fire grate 21. A flame tube 30 is above the burner 20. The flame tube 30 is passing through the top 13 of the combustion cabinet 10.

The baking cabinet 2 further has an outer baking box 40. The outer baking box 40 is a cuboid having a top opening 41 for placing foods. As shown in FIG. 5, the outer baking box 40 has an inner baking box 42 therein. The inner baking box 42 is also a cuboid having a bottom opening 43. A plurality of heat dissipating opening 44 is defined in a top surface of the inner baking box 42. One end of the cuboid outer baking box 40 is a proximal end and the other end thereof is a distal end. A flame opening 45 is defined in the bottom at the proximal end. The flame tube 30 is in alignment to the flame opening 45. A plurality of second air supply holes 31 is defined in the flame tube 30 at a position above the top 13. As shown in this preferred embodiment, the plurality of second air supply holes 31 is in a row and having an equal distance. A density of the heat dissipating openings 44, i.e., a quantity of the heat dissipating openings 44 in a unit length, increases from the proximal end to the distal end of the inner baking box 42.

The auxiliary equipment cabinet 3 has a fuel supplying mechanism 50 and an electrical equipment 60 received therein. The fuel supplying mechanism 50 has a hopper 51, a fuel supplying tube 52 having one end in communication to an opening under the hopper 51 and the other end extending into the burning zone 24, and a rotary vane feeder 53 received in the fuel supplying tube 52. As shown in FIG. 6, the electrical equipment 60 has a feeding motor 61 for driving the rotary vane feeder 53, an air blower 62 which is able to supply air to the air supply zone 23 of the burner 20, a power supply 63, a switch 64 and a power light 65. The power supply 63 may be an independent alternating current/direct current power supply 631, having or having not a storage battery 632 in parallel as auxiliary. Either the alternating current/direct current power supply 631 or the storage battery 632 is able to supply power independently. The switch 64 is installed on the auxiliary equipment cabinet 3 and able to control the power supply of whole circuit. The power light 65 is also installed on the auxiliary equipment cabinet 3 near the switch 64 and used to indict status of power supply.

Fuel 70 is biomass fuel granule made by smashed and then briquetted straw, bits of wood, or crop stalks. For easier movement, rollers 101 are able to be installed on the stand 1 as shown in FIGS. 1, 3 and 4.

In use, a user is able to place the stand 1 stably on the ground first and then pour biomass fuel 70 into the hopper 51. When the user turns on the switch 64, the power light 65 turns on which means the power is on and the oven is ready for work. The feeding motor 61 starts to rotate and drives the rotary vane feeder 53 to convey the fuel 70 into the burner 20. The fuel 70 falls onto the fire grate 21 under gravity. At this time, the user is able to ignite the fuel 70 by throwing a burning alcoholic cotton ball into the burner 20 on the fuel 70. Also at this time, the air blower 62 starts to supply air to the air supply zone 23 in the combustion cabinet 10. Air enters into the burning zone 24 through the first air supply holes 25 in the fire grate 21 and supplies oxygen for the burning of the fuel 70. The fuel 70 is able to generate low density combustible gas when burn to a certain degree. The combustible gas burns and flow under a current produced by the air blower 62. The burning flow passes by the flame tube 30 and the flame opening 45 under the outer baking box 40 and enters the long and narrow passageway defined by the bottom of the outer baking box 40 and the inner baking box 42. The burning flow constantly exits the inner baking box 42 from the heat dissipating openings 44 in a process of flowing to the distal end. A temperature of the burning flow at the proximal end is high and the temperature at the distal end is low however the quantity of the heat dissipating openings 44 near the proximal end is less than the quantity near the distal end. Therefore, a flow rate at the proximal end is smaller and the flow rate at the distal end is greater. As a result, a temperature of the whole striped baking area is basically the same. Air is able to enter the flame tube 30 through the second air supply holes 31 in the flame tube 30 and supply air at a second time, making a more complete burning of the combustible gas.

When the burning needs to be stopped, the user is able to turns off the switch 64. The power light 65 goes off, the feeding motor 61 ceases, and the air blower 62 stops. No new fuel 70 will be supplied and the fuel 70 in the burning zone 24 will be exhausted very quickly. The user will be able to open the door 14 and collect ash in the air supply zone 23. A peripheral of the fire grate 21 is able to be oblique upward to a certain degree, forming a central depression. The central depression is able to help concentrate the fuel 70 to avoid black smoke produced by the peripheral fuel which is not heated completely.

1. A barbeque oven for use with biomass fuel (70) granule and comprising:
a stand (1) placable on the ground and a baking cabinet (2) and an auxiliary equipment (3) on the stand (1);
the baking cabinet (2) having a combustion cabinet (10) and a burner (20) received therein, the combustion cabinet (10) having a bottom (11) near the ground, a side (12) extending upward from the bottom (11), and a top (13) in connection to an upper periphery of the side (12) and facing to the bottom (11), the burner (20) having, a fire grate (21), a side wall (22) extending upward from the fire grate (21), and an air supply zone (23) under the fire grate (21), a burning zone (24) beyond the fire grate (21) being defined by the side wall (22), a plurality of first air supply holes (25) being defined in the fire grate (21), a flame tube (30) being above the burner (20), the flame tube (30) being passing through the top (13) of the combustion cabinet (10);
the baking cabinet (2) further having an outer baking box (40), the outer baking box (40) being a cuboid having a top opening (41) for placing foods, the outer baking box (40) having an inner baking box (42) therein, the inner baking box (42) being also a cuboid having a bottom opening (43), a plurality of heat dissipating opening (44) being defined in the inner baking box (42), one end of the cuboid outer baking box (40) being a proximal end and the other end thereof being a distal end, a flame opening (45) being defined in the bottom at the proximal end, the flame tube (30) being in alignment to the flame opening (45), a density of the heat dissipating openings (44) increasing from the proximal end to the distal end of the inner baking box (42);
the auxiliary equipment, cabinet (3) having a fuel supplying mechanism (50) and an electrical equipment (60) received therein;
the fuel supplying mechanism (50) having a hopper (51), a fuel supplying tube (52) having one end in communication to an opening under the hopper (51) and the other end extending into the burning zone (24), and a rotary vane feeder (53) received in the fuel supplying tube (52);
the electrical equipment (60) having a feeding motor (61) for driving the rotary vane feeder (53), an air blower (62) which is able to supply air to the air supply zone (23) of the burner (20), a power supply (63), and a switch (64).

2. The barbeque oven as claimed in claim 1, wherein a plurality of second air supply holes (31) is defined in the flame tube (30) above the top (13).
